(19) United States
(12) Patent Application Publication
(10) Pub. No.: US 2026/0041119 A1
(43) Pub. Date: Feb. 12, 2026

(54) MEAT SUBSTITUTE PRODUCT

(71) Applicant: Cargill, Incorporated, Wayzata, MN (US)

(72) Inventors: Franky Franciscus Antonius HOLLANDER, Ochten (NL); Zuzana VAN BEVEREN, Hombeek (BE)

(21) Appl. No.: 19/100,822

(22) PCT Filed: Aug. 11, 2023
(86) PCT No.: PCT/US2023/072071

§ 371 Date: Feb. 3, 2025

(30) Foreign Application Priority Data
Aug. 11, 2022 (EP) 22189904.0

(51) Int. Cl. A23J 3/22; A23D 9/05; A23J 3/14; A23L 29/00; A23P 30/20

(52) U.S. Cl. CPC A23J 3/227; A23D 9/05; A23J 3/14; A23L 29/04; A23P 30/20

(57) ABSTRACT

The present invention relates to a meat substitute product comprising a texturized protein ingredient and an emulsion that is comprising a binding agent, a liquid oil, water and a powdered vegetable fat having that is a randomly interesterified and is having fatty acid moiety comprising saturated fatty acids with a carbon chain length of 12 to 22 (C12-C22), and having a ratio of saturated fatty acids with a carbon chain length of 12 and 14 (C12-C14) over saturated fatty acids with a carbon chain length of from 16 to 22 (C16-C22) of from 0.30 to 1.00, and wherein the emulsion is present in an amount of from 20 to 50 wt. %, from 25 to 45 wt. %, or from 30 to 40 wt. % on total weight of the meat substitute product. It further relates to the process for preparing the meat substitute product.

### CROSS-REFERENCE TO RELATED APPLICATIONS

This application claims the benefit of European Application No. 22189904.0, filed Aug. 11, 2022, which is incorporated by reference herein in its entirety.

### FIELD OF THE INVENTION

The present invention relates to a meat substitute product comprising a texturized protein ingredient and an emulsion. The emulsion is comprising a randomly interesterified vegetable fat in powdered form.

### BACKGROUND OF THE INVENTION

Traditionally, meat products have taken an important place in our western diet. Meat products are consumed in many different forms as whole muscle or minced pieces of meat that are cooked, grilled, smoked, cured or fermented in form of hamburgers, patties, sausages, balls, nuggets and many more.

There is a growing consumer trend for reducing or completely removing these animal products from their diet. Consumers switch towards plant-based meat substitutes because of various reasons such as health concerns, environmental concerns, sustainability or animal welfare.

In order for a regular meat consumer to be motivated to choose for meat substitutes, it is critical that these substitutes mimic the fibrous qualities provided by animal muscle fiber. The meat substitutes should resemble meat products in terms of appearance and texture during and after cooking. They should mimic organoleptic properties, like appearance, flavor, bite, succulence and mouthfeel when being consumed.

Various functional ingredients in meat substitutes are required to mimic the taste, flavor, texture, mouthfeel and appearance of meat-based products. Additionally, various functional ingredients will also affect the production efficiency of the meat substitutes for example in terms of losses during preparation, formation and cooking of the products; and ease of cleaning the equipment for preparing the products.

There is still a need to improve the organoleptic properties and/or production efficiency of meat substitute products and more specifically of minced meat substitute products. The present invention provides such a solution.

### SUMMARY OF THE INVENTION

The present invention relates to a meat substitute product comprising a texturized protein ingredient and an emulsion that is comprising:
a binding agent
a liquid oil
a powdered vegetable fat, and
water,
wherein the powdered vegetable fat is a randomly interesterified fat having a fatty acid moiety comprising saturated fatty acids with a carbon chain length of 12 to 22 (C12-C22), and having a ratio of saturated fatty acids with a carbon chain length of 12 and 14 (C12-C14) over saturated fatty acids with a carbon chain length of from 16 to 22 (C16-C22) of from 0.30 to 1.00, from 0.40 to 0.90, or from 0.50 to 0.80, wherein the emulsion is present in an amount of from 20 to 50 wt. %, from 25 to 45 wt. %, or from 30 to 40 wt. % on total weight of the meat substitute product.

The present invention further relates to the meat substitute product prepared by adding an emulsion to a texturized protein ingredient and the emulsion is comprising:
a binding agent
a liquid oil
a powdered vegetable fat, and
water,
wherein the powdered vegetable fat is a randomly interesterified fat having a fatty acid comprising saturated fatty acids with a carbon chain length of 12 to 22 (C12-C22), and having a ratio of saturated fatty acids with a carbon chain length of 12 and 14 (C12-C14) over saturated fatty acids with a carbon chain length of from 16 to 22 (C16-C22) of from 0.30 to 1.00, from 0.40 to 0.90, or from 0.50 to 0.8.

It further relates to a process for preparing a meat substitute product of the present invention and the process is comprising the steps of:
a) mixing hydrated texturized protein, with an emulsion, and optionally other ingredients, and obtaining a meat substitute dough, and
b) shaping of the meat substitute dough into a form,
wherein the emulsion is comprising:
   a binding agent
   a liquid oil
   a powdered vegetable fat, and
   water,
wherein the powdered vegetable fat is a randomly interesterified fat having a fatty acid comprising saturated fatty acids with a carbon chain length of 12 to 22 (C12-C22), and having a ratio of saturated fatty acids with a carbon chain length of 12 and 14 (C12-C14) over saturated fatty acids with a carbon chain length of from 16 to 22 (C16-C22) of from 0.30 to 1.00, from 0.40 to 0.90, or from 0.50 to 0.8.

It further relates to the use of an emulsion to improve the fat binding ability in the preparation of a meat substitute product, and the emulsion is comprising:
a binding agent
a liquid oil
a powdered vegetable fat, and
water,
wherein the powdered vegetable fat is a randomly interesterified fat having a fatty acid comprising saturated fatty acids with a carbon chain length of 12 to 22 (C12-C22) and having a ratio of saturated fatty acids with a carbon chain length of 12 and 14 (C12-C14) over saturated fatty acids with a carbon chain length of from 16 to 22 (C16-C22) of from 0.30 to 1.00, from 0.40 to 0.90, or from 0.50 to 0.8.

### DETAILED DESCRIPTION

The present invention relates to a meat substitute product comprising a texturized protein ingredient and an emulsion that is comprising:
a binding agent
a liquid oil
a powdered vegetable fat, and
water,
wherein the powdered vegetable fat is a randomly interesterified fat having a fatty acid moiety comprising saturated fatty acids with a carbon chain length of 12 to 22 (C12-C22), and having a ratio of saturated fatty acids with a carbon chain length of 12 and 14 (C12-C14) over saturated fatty acids with a carbon chain length of from 16 to 22 (C16-C22) of from 0.30 to 1.00, from 0.40 to 0.90, or from 0.50 to 0.80, wherein the emulsion is present in an amount of from 20 to 50 wt. %, from 25 to 45 wt. %, or from 30 to 40 wt. % on total weight of the meat substitute product.

The present invention further relates to the meat substitute product prepared by adding an emulsion to a texturized protein ingredient and the emulsion is comprising:
a binding agent
a liquid oil
a powdered vegetable fat, and
water,
wherein the powdered vegetable fat is a randomly interesterified fat having a fatty acid comprising saturated fatty acids with a carbon chain length of 12 to 22 (C12-C22), and having a ratio of saturated fatty acids with a carbon chain length of 12 and 14 (C12-C14) over saturated fatty acids with a carbon chain length of from 16 to 22 (C16-C22) of from 0.30 to 1.00, from 0.40 to 0.90, or from 0.50 to 0.8.

Meat substitute products are food or feed compositions that mimic animal processed whole-muscle meat products as well as processed restructured meat products such as burgers, patties, sausages and the like. Methods of processing may be salting, chopping, fermentation, boiling, smoking, extrusion or other processes.

Meat substitute products can be divided into minced, also called ground, products and fine paste products. Minced meat substitute products are coarse-particle products such as alternatives for burgers, patties, sausages, balls, nuggets and the like. Fine paste products are typically emulsified products such as alternatives for frankfurter, bologna, mortadella and the like.

The meat substitute product according to the present invention may be a minced meat substitute product.

The minced meat substitute product according to the invention may be shaped in any form, such as the form of a burger, a patty, a ball, a nugget or a sausage. Preferably, the meat substitute product according to the present invention is a minced and shaped meat substitute product.

The meat substitute product according to the invention may be a vegetarian protein product. The vegetarian protein product is not based on meat or fish. More preferably the meat substitute product is a vegan protein product. The vegan protein product is not based on ingredients derived from animals. Examples of ingredients derived from animals are amongst others meat, fish, eggs, milk or honey.

The meat substitute product according to the present invention may be uncooked. The meat substitute product according to the present invention is designed for consumption after cooking.

The meat substitute product according to the present invention comprises a texturized protein ingredient. A texturized protein ingredient is a fibrous protein product. It may enhance the textural and sensorial quality of the meat substitute product. It may influence the bite, succulence and/or moistness of the meat substitute product. Preferably, the texturized protein ingredient is from a vegetable source, i.e. a texturized vegetable protein. A texturized vegetable protein is a processed vegetable product usually made from high protein flour or its protein concentrate through an extrusion process at high temperature and pressure to produce a fibrous, insoluble and porous product. The texturized vegetable protein is sourced amongst others from soy, pea, corn, cottonseed, wheat, sunflower seed, oats or combinations of two or more thereof. More preferably, the texturized protein ingredient is sourced from soy, pea, wheat, sunflower, or mixtures of two or more thereof. More preferably, the texturized protein ingredient is texturized soy protein and/or texturized pea protein.

The texturized protein ingredient may be present in the meat substitute product in hydrated form in an amount of from 30 to 80 wt. %, from 35 to 75 wt. %, or from 40 to 70 wt. % on total weight of the meat substitute product. More specifically, texturized protein ingredient may be present in the meat substitute product in hydrated form in an amount of from 47 to 55 wt. %, such as 52 wt. % on total weight of the meat substitute product.

The meat substitute product according to the present invention also comprises an emulsion comprising a binding agent, a liquid oil, a powdered vegetable fat and water.

Without being bound by any theory, the emulsion of the meat substitute product of the present invention may be an oil-in-water emulsion whereby the water phase is the continuous phase wherein fine oil droplets and the powdered vegetable fat are dispersed. The binding agent that is dispersed in the water phase may give a stabilizing and/or gelling effect. The emulsion is functioning as a binder in the meat substitute product. It binds the texturized protein ingredient such that it may be formed in the shape of a patty, a ball, a sausage or a nugget or any desired shape.

The emulsion may be present in the meat substitute product according to the invention in an amount of from 20 to 50 wt. %, from 25 to 45 wt. %, or from 30 to 40 wt. % on total weight of the meat substitute product.

The binding agent in the emulsion of the meat substitute product may be a hydrocolloid. Preferably the binding agent is a hydrocolloid selected from the group consisting of alginate, pectin, carrageenan, gelatin, gellan, agar, and combinations of two or more thereof. More preferably, the binding agent is methylcellulose or a combination of methylcellulose and at least one other hydrocolloid than methylcellulose. For example, the binding agent may be methylcellulose or a combination of methylcellulose and carrageenan.

The binding agent may be present in the emulsion of the meat substitute product according to the invention in an amount of at least 0.1 wt. %, at least 0.3 wt. %, or at least 0.5 wt. % based on total weight of the emulsion. Preferably, the binding agent is present in an amount of from 0.1 to 5 wt. %, from 0.3 to 4 wt. %, from 0.5 to 3 wt. %, for example 2.6 wt. % on total weight of the emulsion.

The term “liquid oil” in the present invention is defined as a triglyceride with a melting point of less than 20° C. The liquid oil can be one liquid oil or a blend of more than one liquid oil. In case of a blend of liquid oils, it is understood that the blend of the more than one liquid oil has a melting point of less than 20° C.

The “liquid oil” is a vegetable oil.

Examples of vegetable liquid oils are amongst others double fractionated palm olein, cottonseed oil, corn oil, groundnut oil, linseed oil, olive oil, rapeseed oil, rice bran oil, sesame oil, safflower oil, soybean oil, sunflower oil, oil from any variety of oilseeds with increased level of unsaturated fatty acids compared to the original seed variety, such as mid or high oleic sunflower oil. These varieties with increased levels of unsaturated fatty acids can be obtained by natural selection or by genetic modification (GMO). Preferably, the vegetable oil is selected from the group consisting of cottonseed oil, corn oil, groundnut oil, linseed oil, olive oil, rapeseed oil, rice bran oil, sesame oil, safflower oil, soybean oil, sunflower oil, their corresponding high oleic varieties, and mixture of two or more thereof. More preferably, the vegetable oil is selected from the group consisting of corn oil, rapeseed oil, soybean oil, sunflower oil, their corresponding high oleic varieties, and mixture of two or more thereof. The high oleic varieties are containing at least 40%, at least 50%, at least 60%, at least 70% and preferably at least 80% oleic acid in respect of the fatty acid profile.

The liquid oil may be present in the emulsion of the meat substitute product according to the invention in an amount of from 7.0 to 48.0 wt. %, from 10.0 to 45.0 wt. %, or from 12.5 to 42.0 wt. % based on total weight of the emulsion. Preferably, the liquid oil is present in an amount of from 7.5 to 15.0 wt. %, for example 10.0 to 11.0 wt. % on total weight of the emulsion.

The vegetable fat in the emulsion is in powdered form. The term “powdered vegetable fat” is encompassing solid vegetable fats that are in the form of microparticles. Preferably the powdered vegetable fat has an average particle size in a range of from 30 to 350 micron (μm, micrometer), from 50 to 330 micron, from 80 to 300 micron, measured by laser diffraction. The powdered vegetable fat may be obtained by any suitable process for obtaining a solid fat in form of microparticles, such as, but not limited to spray-cooling (also called spray-chilling) or supercritical melt micronization. Preferably the powdered vegetable fat is obtained by any means of spray-cooling.

The powdered vegetable fat may be present in the emulsion of the meat substitute product according to the invention in an amount of from 7.0 to 48.0 wt. %, from 10.0 to 45.0 wt. %, or from 12.5 to 42.0 wt. % based on total weight of the emulsion. Preferably, the powdered vegetable fat is present in an amount of from 7.5 to 15.0 wt. %, for example 10.0 to 11.0 wt. % on total weight of the emulsion.

The liquid oil and the powdered vegetable fat may be present in the emulsion of the meat substitute product according to the present invention in a ratio liquid oil over powdered vegetable fat of from 0.3 to 3.0, from 0.5 to 2.0, from 0.7 to 1.3.

The liquid oil and the powdered vegetable fat may be present in the emulsion of the meat substitute product according to the present invention in a combined amount in a range of from 14.0 to 65.0 wt. %, from 20.0 to 60.0 wt. %, or from 25.0 to 55.0 wt. % based on total weight of the emulsion. Preferably, the liquid oil and the powdered vegetable fat are present in a combined amount of from 20.0 to 30.0 wt. %, for example 20.0 to 22.0 wt. % on total weight of the emulsion.

The powdered vegetable fat is a randomly interesterified fat, which is a triglyceride composition wherein the fatty acids are randomly distributed over the glycerol backbone of the triglycerides.

The randomly interesterified fat can be obtained by means of a process of chemical or enzymatic interesterification. Preferably, the randomly interesterified fat is obtained by means of a chemical interesterification.

A chemical interesterification is performed by using an acidic or basic catalyst, preferably a basic catalyst, such as, but not limited to, sodium methoxide or sodium ethoxide. An enzymatic interesterification is obtained by means of a lipase enzyme. The lipase will generally be non-selective for the positions on the glyceride backbone in order to achieve the optimum random interesterification. Alternatively, selective lipases may be used, provided that the reaction conditions are such that no significant selectivity is observed, for example by running the reaction for extended periods of time. Suitable lipases include the lipases from Thermomyces lanuginosa, Rhizomucor miehei, Rhizopus delemar and Candida rugosa. Preferably, the lipase is suitable for use with food products.

It may be that the interesterification is not fully random, but it is preferably random to a large extent, for example greater than 75%, greater than 85%, preferably greater than 95% of the fatty acid residues may change position during the reaction i.e. less than 25%, less than 15%, preferably less than 5% of the fatty acids retain their original position of the starting triglyceride.

The interesterified triglyceride may be characterized by the position of the saturated (S) and/or unsaturated (U) fatty acids bound onto the glycerol backbone of the triglyceride.

Typically, the abbreviation S is used to denote a saturated fatty acid residue having 12 to 24 carbon atoms. The abbreviation U denotes an unsaturated fatty acid residue having 12 to 24 carbon atoms. Thus, a triglyceride having saturated fatty acids at the 1- and 3-positions and an unsaturated fatty acid at the 2-position of the glycerol backbone is denoted SUS. Likewise, a triglyceride having 2 saturated fatty acids at the 1- or 3-position and at the 2-position of the glycerol backbone and an unsaturated fatty acid at the remaining 1- or 3-position is denoted SSU.

The ratio of SUS over SSU (SUS/SSU) of a fully randomized triglyceride composition is 0.5, whereas the SUS/SSU ratio of a non-randomized triglyceride is significantly higher than 1.

In one aspect of the invention, the triglyceride composition of the randomly interesterified fat is characterized by a ratio of SUS over SSU (SUS/SSU) in a range of from 0.5 to 1.0, from 0.5 to 0.9, or from 0.5 to 0.8.

The randomly interesterified fat has fatty acid moiety comprising saturated fatty acids with a carbon chain length of 12 to 22 (C12-C22), and having a ratio of saturated fatty acids with a carbon chain length of 12 and 14 (C12-C14) over saturated fatty acids with a carbon chain length of from 16 to 22 (C16-C22) of from 0.30 to 1.00, from 0.40 to 0.90, or from 0.50 to 0.80.

The saturated fatty acids of the randomly interesterified fat with a carbon chain length of 12 and 14 may be sourced from at least one lauric fat. The at least one lauric fat is a fat that is rich in saturated fatty acids with a carbon chain length of 12 and 14. Examples of lauric fat are, but are not limited to, coconut oil, hydrogenated coconut oil, palm kernel oil, fully or partially hydrogenated palm kernel oil, palm kernel stearin, hydrogenated palm kernel stearin, palm kernel olein, fully or partially hydrogenated palm kernel olein, or a mixture of two or more thereof. Preferably, the at least one lauric fat is selected from the group consisting of coconut oil, hydrogenated coconut oil, palm kernel oil, fully or partially hydrogenated palm kernel oil, palm kernel stearin, hydrogenated palm kernel stearin, palm kernel olein, fully or partially hydrogenated palm kernel olein, or a mixture of two or more thereof. More preferably, the at least one lauric fat is coconut oil, hydrogenated coconut oil or a mixture thereof.

The saturated fatty acids of the randomly interesterified fat with a carbon chain length of from 16 to 22 may be sourced from at least one non-lauric fat with an iodine value of less than 37, less than 25, less than 17, or even less than 5. Examples of non-lauric fats with an iodine value of less than 37 are amongst others palm stearin (iodine value 32-36), palm superstearin (iodine value 14-16), fully or partially hydrogenated oils such as, but not limited to, hydrogenated palm olein, hydrogenated liquid oils, or combinations of two or more thereof. Examples of hydrogenated liquid oils are hydrogenated sunflower oil, hydrogenated rapeseed oil, hydrogenated soybean oil, hydrogenated corn oil, and the like. Preferably, the at least one non-lauric fat with an iodine value of less than 37 is a hydrogenated liquid oil with an iodine value of less than 5, less than 4, less than 3, or even less than 2. Hydrogenated liquid oils with an iodine value of less than 5 are fully hydrogenated liquid oils.

Preferably, the randomly interesterified fat is not a hydrogenated fat.

Preferably randomly interesterified fat is not sourced from palm. Example of fats sourced from palm are palm oil, palm oil fractions, palm kernel oil, palm kernel oil fractions or any combination of two or more thereof. In addition to the growing trend of consumers who switch to plant-based meat alternatives, consumers also want to ban palm oil from their diet because of sustainability concerns.

The randomly interesterified fat may have a fatty acid moiety comprising a content of saturated fatty acids of at least 70 wt. %, at least 80 wt. %, at least 90 wt. %, or at least 92 wt. % on total weight of the fatty acid moiety. More specifically, the randomly interesterified fat may have a fatty acid moiety comprising a content of saturated fatty acids in a range of from 70 wt. % to 100.0 wt. %, from 80 to 98 wt. %, or from 90 to 96 wt. % on total weight of the fatty acid moiety.

The randomly interesterified fat may have a fatty acid moiety comprising a combined content of saturated fatty acids with a carbon chain length of 12 and 14 in range of from 16 to 40 wt. %, from 20 to 38 wt. %, or from 25 to 35 wt. %. Furthermore, the randomly interesterified triglyceride may have a fatty acid moiety comprising a combined content of saturated fatty acids with a carbon chain length of from 16 to 22 in a range of from 40 to 65 wt. %, from 44 to 62 wt. %, or from 48 to 60 wt. % on total weight of the fatty acid moiety.

The randomly interesterified triglyceride may have a melting point of more than 35° C., more than 40° C., or even more than 45° C. The melting point can be determined according to the official AOCS method Cc 3-25.

In a preferred aspect of the invention, the powdered vegetable fat has:
an average particle size in a range of from 30 to 350 micron (μm, micrometer), from 50 to 330 micron, from 80 to 300 micron;
a triglyceride composition having a ratio of SUS over SSU (SUS/SSU) in a range of from 0.5 to 1.0, from 0.5 to 0.9, or from 0.5 to 0.8;
a fatty acid moiety comprising, expressed on total weight of the fatty acid moiety:
   a combined content of saturated fatty acids with a carbon chain length of 12 and 14 (C12-C14) in range of from 16 to 40 wt. %, from 20 to 38 wt. %, or from 25 to 35 wt. %;
   a combined content of saturated fatty acids with a carbon chain length of from 16 to 22 (C16-C22) in a range of from 40 to 65 wt. %, from 44 to 62 wt. %, or from 48 to 60 wt. %, and
   a ratio (C12-C14) over (C16-C22) of from 0.30 to 1.00, a ratio of from 0.40 to 0.90, or a ratio of from 0.50 to 0.80.

In a more preferred aspect of the invention, the powdered vegetable fat has:
an average particle size in a range of from 30 to 350 micron (μm, micrometer), from 50 to 330 micron, from 80 to 300 micron;
a triglyceride composition having a ratio of SUS over SSU (SUS/SSU) in a range of from 0.5 to 1.0, from 0.5 to 0.9, or from 0.5 to 0.8;
a fatty acid moiety comprising, expressed on total weight of the fatty acid moiety:
   a combined content of saturated fatty acids with a carbon chain length of 12 and 14 (C12-C14) in range of from 16 to 40 wt. %, from 20 to 38 wt. %, or from 25 to 35 wt. %;
   a combined content of saturated fatty acids with a carbon chain length of from 16 to 22 (C16-C22) in a range of from 40 to 65 wt. %, from 44 to 62 wt. %, or from 48 to 60 wt. %, and
   a ratio (C12-C14) over (C16-C22) of from 0.30 to 1.00, a ratio of from 0.40 to 0.90, or a ratio of from 0.50 to 0.80, wherein the powdered vegetable fat is not sourced from palm and/or hydrogenated triglycerides.

The term “water” in the present invention is encompassing pure water, tap water, bottled water, deionized water, spring water, an aqueous solution, or any combination thereof. The water may also be sourced from an aqueous solution comprising salts and/or minerals, a broth, a juice or a modified juice of a plant or a plant part, or a mixture of two or more thereof.

The water may be present in the emulsion of the meat substitute product in an amount of from 35.0 to 85.0 wt. %, from 40.0 to 80.0 wt. %, or from 45.0 to 75.0 wt. % based on total weight of the emulsion. Preferably, the water is present in an amount of from 70.0 to 80.0 wt. %, for example 76.0 wt. % on total weight of the emulsion.

The binding agent, the liquid oil, the powdered vegetable fat and the water of the emulsion in the meat substitute product according to the present invention may have a combined content of at least 90 wt. %, at least 92 wt. %, or at least 95 wt. % on total weight of the emulsion.

Beyond the binding agent of the emulsion, the meat substitute product according to the present invention may further comprise a texturing ingredient. Examples of texturing ingredients are hydrocolloids such as, but not limited to, starches, xanthan gum, guar gum, locust bean gum, konjac gum, cellulose derivatives, alginate, pectin, carrageenan, gellan gum, agar, plant fibers or combinations of two or more thereof.

Starches may be from various botanical sources, such as potato starch or maize starch. They may be in form of native starch, physically or chemically modified starch, or a mixture of two or more thereof. Cellulose derivatives may be methyl cellulose, carboxymethyl cellulose and/or hydroxypropyl methylcellulose. Plant fibers may be citrus fiber, carrot fiber or chicory root fiber.

The amount of each texturing ingredient, if present, is preferably in a range of from 0.1 to 3.0 wt %, from 0.2 to 2.5 wt %, or from 0.3 to 2.0 wt % on the total weight of the meat substitute product. Preferably, the texturing ingredient is selected from the group consisting of starch, cellulose derivates, carrageenan, xanthan gum or fiber.

The meat substitute product according to the present invention may further comprises one or more ingredients selected from the group consisting of sodium chloride, sodium ascorbates, citrates, sodium carbonates, sweeteners, flavoring agents, flavor enhancers, spices/seasonings, preservatives, and combinations of two or more thereof. The amount of each ingredient, if present, is preferably in a range of from 0.01 to 2.0 wt %, from 0.02 to 1.0 wt % on the total weight of the meat substitute product.

The meat substitute product according to the present invention may further comprises solid fat particles. The solid fat particles may have an average particle size of more than 1.0 mm, more than 1.5 mm, or more than 2.0 mm (mm=millimeter). The fat of the solid fat particles may be the same or a different fat than the powdered vegetable fat that is present in the emulsion. Preferably, the fat of the solid fat particles is the same as the powdered vegetable fat that is present in the emulsion. The solid fat particles may be obtained by flaking or grinding of the solid fat. The solid fat particles may be added to the meat substitute product to mimic the visual aspect of minced meat.

Preferably, the meat substitute product according to the present invention comprises substantially no ingredients sourced from palm. In addition to the growing trend of consumers to switch to plant-based meat alternatives, consumers also want to ban palm oil from their diet because of sustainability concerns.

It was surprisingly found that when the powdered vegetable fat that is present in the emulsion of the meat substitute product according to the invention, is a randomly interesterified fat, the loss of product during preparation and/or shape formation of the meat substitute is reduced compared to the loss of product occurring during preparation and/or shape formation of existing meat alternative products. Consequently, it may also be easier to clean the equipment that is used for preparing the meat substitute product according to the invention, since less product remains sticking to the equipment.

Furthermore, it was also found that the presence of the randomly interesterified fat as powdered vegetable fat in the emulsion of the meat substitute product according to the invention results in an improved sensorial quality. The presence of a randomly interesterified fat as powdered vegetable fat in the emulsion of the meat substitute product may result in an improved juiciness while maintaining sensorial characteristics such as firmness of bite, oily mouthfeel and/or graininess within the same range as for existing meat substitute products.

It further relates to a process for preparing a meat substitute product of the present invention and the process is comprising the steps of
a) mixing hydrated texturized protein, with an emulsion, and optionally other ingredients, and obtaining a meat substitute dough, and
b) shaping of the meat substitute dough into a form,
wherein the emulsion is comprising:
   a binding agent
   a liquid oil
   a powdered vegetable fat, and
   water, and
wherein the powdered vegetable fat is a randomly interesterified fat having a fatty acid comprising saturated fatty acids with a carbon chain length of 12 to 22 (C12-C22), and having a ratio of saturated fatty acids with a carbon chain length of 12 and 14 (C12-C14) over saturated fatty acids with a carbon chain length of from 16 to 22 (C16-C22) of from 0.30 to 1.00, from 0.40 to 0.90, or from 0.50 to 0.8.

Preferably, all steps for the preparation of the meat substitute dough are executed at a temperature below 8° C. The shaped forms can be stored at 4° C., can be frozen at −18° C. or can be heat treated (like steam cooking, pan frying or oven baking) prior to storing at 4° C. or freezing at −18° C.

It further relates to the process wherein it includes the preparation of the emulsion that is further mixed with hydrated texturized protein, and optionally other ingredients. Finally, it relates to the use of an emulsion to improve the fat binding ability in the preparation of a meat substitute product, and the emulsion is comprising:
a binding agent
a liquid oil
a powdered vegetable fat, and
water,
   wherein the powdered vegetable fat is a randomly interesterified fat having a fatty acid comprising saturated fatty acids with a carbon chain length of 12 to 22 (C12-C22), and having a ratio of saturated fatty acids with a carbon chain length of 12 and 14 (C12-C14) over saturated fatty acids with a carbon chain length of from 16 to 22 (C16-C22) of from 0.30 to 1.00, from 0.40 to 0.90, or from 0.50 to 0.8.

### Clauses

1. A meat substitute product comprising a texturized protein ingredient and an emulsion that is comprising:
   a binding agent
   a liquid oil
   a powdered vegetable fat, and
   water,
wherein the powdered vegetable fat is a randomly interesterified fat having a fatty acid comprising saturated fatty acids with a carbon chain length of 12 to 22 (C12-C22), and having a ratio of saturated fatty acids with a carbon chain length of 12 and 14 (C12-C14) over saturated fatty acids with a carbon chain length of from 16 to 22 (C16-C22) of from 0.30 to 1.00, from 0.40 to 0.90, or from 0.50 to 0.8.
2. The meat substitute product of clause 1 wherein the emulsion is present in an amount of from 20 to 50 wt. % on total weight of the meat substitute product.
3. The meat substitute product of clause 1 wherein the emulsion is present in an amount of from 25 to 45 wt. % on total weight of the meat substitute product.
4. The meat substitute product of clause 1 wherein the emulsion is present in an amount of from 30 to 40 wt. % on total weight of the meat substitute product.
5. The meat substitute product of clause 1 prepared by adding an emulsion to a texturized protein ingredient and the emulsion is comprising:
   a binding agent
   a liquid oil
   a powdered vegetable fat, and
   water,
wherein the powdered vegetable fat is a randomly interesterified fat having a fatty acid comprising saturated fatty acids with a carbon chain length of 12 to 22 (C12-C22), and having a ratio of saturated fatty acids with a carbon chain length of 12 and 14 (C12-C14) over saturated fatty acids with a carbon chain length of from 16 to 22 (C16-C22) of from 0.30 to 1.00.
6. The meat substitute product of clause 1 prepared by adding an emulsion to a texturized protein ingredient and the emulsion is comprising:
   a binding agent
   a liquid oil
   a powdered vegetable fat, and
   water,
wherein the powdered vegetable fat is a randomly interesterified fat having a fatty acid comprising saturated fatty acids with a carbon chain length of 12 to 22 (C12-C22), and having a ratio of saturated fatty acids with a carbon chain length of 12 and 14 (C12-C14) over saturated fatty acids with a carbon chain length of from 16 to 22 (C16-C22) of from 0.40 to 1.00.
7. The meat substitute product of clause 1 prepared by adding an emulsion to a texturized protein ingredient and the emulsion is comprising:
   a binding agent
   a liquid oil
   a powdered vegetable fat, and
   water,
wherein the powdered vegetable fat is a randomly interesterified fat having a fatty acid comprising saturated fatty acids with a carbon chain length of 12 to 22 (C12-C22), and having a ratio of saturated fatty acids with a carbon chain length of 12 and 14 (C12-C14) over saturated fatty acids with a carbon chain length of from 16 to 22 (C16-C22) of from 0.40 to 0.90.
8. The meat substitute product of clause 1 prepared by adding an emulsion to a texturized protein ingredient and the emulsion is comprising:
   a binding agent
   a liquid oil
   a powdered vegetable fat, and
   water,
wherein the powdered vegetable fat is a randomly interesterified fat having a fatty acid comprising saturated fatty acids with a carbon chain length of 12 to 22 (C12-C22), and having a ratio of saturated fatty acids with a carbon chain length of 12 and 14 (C12-C14) over saturated fatty acids with a carbon chain length of from 16 to 22 (C16-C22) of from 0.50 to 0.8.
9. The meat substitute product according to any one of preceding clauses wherein the randomly interesterified fat has a fatty acid moiety comprising a combined content of saturated fatty acids with a carbon chain length of 12 and 14 in range of from 16 to 40 wt. %, and a combined content of saturated fatty acids with a carbon chain length of from 16 to 22 in a range of from 40 to 65 wt. %, from 44 to 62 wt. %, or from 48 to 60 wt. % on total weight of the fatty acid moiety.
10. The meat substitute product according to any one of preceding clauses wherein the randomly interesterified fat has a fatty acid moiety comprising a combined content of saturated fatty acids with a carbon chain length of 12 and 14 in range of from 20 to 38 wt. %, and a combined content of saturated fatty acids with a carbon chain length of from 16 to 22 in a range of from 40 to 65 wt. %, from 44 to 62 wt. %, or from 48 to 60 wt. % on total weight of the fatty acid moiety
11. The meat substitute product according to any one of preceding clauses wherein the randomly interesterified fat has a fatty acid moiety comprising a combined content of saturated fatty acids with a carbon chain length of 12 and 14 in range of from 25 to 35 wt. %, and a combined content of saturated fatty acids with a carbon chain length of from 16 to 22 in a range of from 40 to 65 wt. %, from 44 to 62 wt. %, or from 48 to 60 wt. % on total weight of the fatty acid moiety.
12. The meat substitute product according to any one of preceding clauses wherein the randomly interesterified fat has a fatty acid moiety comprising a combined content of saturated fatty acids with a carbon chain length of 12 and 14 in range of from 16 to 40 wt. %, and a combined content of saturated fatty acids with a carbon chain length of from 16 to 22 in a range of from 44 to 65 wt. % on total weight of the fatty acid moiety.
13. The meat substitute product according to any one of the preceding clauses, wherein the texturized protein ingredient is present in hydrated form in an amount of from 30 to 80 wt. % on total weight of the meat substitute product.
14. The meat substitute product according to any one of the preceding clauses, wherein the texturized protein ingredient is present in hydrated form in an amount of from 35 to 75 wt. % on total weight of the meat substitute product.
15. The meat substitute product according to any one of the preceding clauses, wherein the texturized protein ingredient is present in hydrated form in an amount of from 40 to 70 wt. % on total weight of the meat substitute product.
16. A process for preparing a meat substitute product according to any one of the preceding clauses and the process is comprising the steps of:
   a) mixing hydrated texturized protein, with an emulsion, and optionally other ingredients, and obtaining a meat substitute dough, and
   b) shaping of the meat substitute dough into a form,
wherein the emulsion is comprising:
   a binding agent
   a liquid oil
   a powdered vegetable fat, and
   water, and
wherein the powdered vegetable fat is a randomly interesterified fat having a fatty acid comprising saturated fatty acids with a carbon chain length of 12 to 22 (C12-C22), and having a ratio of saturated fatty acids with a carbon chain length of 12 and 14 (C12-C14) over saturated fatty acids with a carbon chain length of from 16 to 22 (C16-C22) of from 0.30 to 1.00.
17. A process for preparing a meat substitute product according to any one of clauses 1 to 15 and the process is comprising the steps of
   a) mixing hydrated texturized protein, with an emulsion, and optionally other ingredients, and obtaining a meat substitute dough, and
   b) shaping of the meat substitute dough into a form,
wherein the emulsion is comprising:
   a binding agent
   a liquid oil
   a powdered vegetable fat, and
   water,
wherein the powdered vegetable fat is a randomly interesterified fat having a fatty acid comprising saturated fatty acids with a carbon chain length of 12 to 22 (C12-C22), and having a ratio of saturated fatty acids with a carbon chain length of 12 and 14 (C12-C14) over saturated fatty acids with a carbon chain length of from 16 to 22 (C16-C22) of from 0.40 to 1.00.
18. A process for preparing a meat substitute product according to any one of clauses 1 to 15 and the process is comprising the steps of
   a) mixing hydrated texturized protein, with an emulsion, and optionally other ingredients, and obtaining a meat substitute dough, and
   b) shaping of the meat substitute dough into a form,
wherein the emulsion is comprising:
   a binding agent
   a liquid oil
   a powdered vegetable fat, and
   water,
wherein the powdered vegetable fat is a randomly interesterified fat having a fatty acid comprising saturated fatty acids with a carbon chain length of 12 to 22 (C12-C22), and having a ratio of saturated fatty acids with a carbon chain length of 12 and 14 (C12-C14) over saturated fatty acids with a carbon chain length of from 16 to 22 (C16-C22) of from 0.40 to 0.90.
19. A process for preparing a meat substitute product according to any one of clauses 1 to 15 and the process is comprising the steps of
   a) mixing hydrated texturized protein, with an emulsion, and optionally other ingredients, and obtaining a meat substitute dough, and
   b) shaping of the meat substitute dough into a form,
wherein the emulsion is comprising:
   a binding agent
   a liquid oil
   a powdered vegetable fat, and
   water,
wherein the powdered vegetable fat is a randomly interesterified fat having a fatty acid comprising saturated fatty acids with a carbon chain length of 12 to 22 (C12-C22), and having a ratio of saturated fatty acids with a carbon chain length of 12 and 14 (C12-C14) over saturated fatty acids with a carbon chain length of from 16 to 22 (C16-C22) of from 0.50 to 0.8.
20. The process of any one of clauses 16 to 19 wherein the emulsion is present in an amount of from 20 to 50 wt. % on total weight of the meat substitute product.
21. The process of any one of clauses 16 to 19 wherein the emulsion is present in an amount of from 25 to 45 wt. % on total weight of the meat substitute product.
22. The process of any one of clauses 16 to 19 wherein the emulsion is present in an amount of from 30 to 40 wt. % on total weight of the meat substitute product.
23. The process of any one of clauses 16 to 22, wherein the randomly interesterified fat has a fatty acid moiety comprising a combined content of saturated fatty acids with a carbon chain length of 12 and 14 in range of from 16 to 40 wt. %, and a combined content of saturated fatty acids with a carbon chain length of from 16 to 22 in a range of from 40 to 65 wt. %, from 44 to 62 wt. %, or from 48 to 60 wt. % on total weight of the fatty acid moiety.
24. The process of any one of clauses 16 to 23, wherein the randomly interesterified fat has a fatty acid moiety comprising a combined content of saturated fatty acids with a carbon chain length of 12 and 14 in range of from 20 to 38 wt. %, and a combined content of saturated fatty acids with a carbon chain length of from 16 to 22 in a range of from 40 to 65 wt. %, from 44 to 62 wt. %, or from 48 to 60 wt. % on total weight of the fatty acid moiety.
25. The process of any one of clauses 16 to 24, wherein the randomly interesterified fat has a fatty acid moiety comprising a combined content of saturated fatty acids with a carbon chain length of 12 and 14 in range of from 25 to 35 wt. %, and a combined content of saturated fatty acids with a carbon chain length of from 16 to 22 in a range of from 40 to 65 wt. %, from 44 to 62 wt. %, or from 48 to 60 wt. % on total weight of the fatty acid moiety.
26. The process of any one of clauses 16 to 25, wherein the randomly interesterified fat has a fatty acid moiety comprising a combined content of saturated fatty acids with a carbon chain length of 12 and 14 in range of from 16 to 40 wt. %, and a combined content of saturated fatty acids with a carbon chain length of from 16 to 22 in a range of from 44 to 65 wt. %.
27. The process of any one of clauses 16 to 26, wherein the texturized protein ingredient is present in hydrated form in an amount of from 30 to 80 wt. % on total weight of the meat substitute product.
28. The process of any one of clauses 16 to 27, wherein the texturized protein ingredient is present in hydrated form in an amount of from 35 to 75 wt. % on total weight of the meat substitute product.
29. The process of any one of clauses 16 to 28, wherein the texturized protein ingredient is present in hydrated form in an amount of from 40 to 70 wt. % on total weight of the meat substitute product.
30. The process of any one of clauses 16 to 29, wherein the binding agent is present in the emulsion in an amount of at least 0.1 wt. % on total weight of the emulsion.
31. The process of any one of clauses 16 to 30, wherein the binding agent is present in the emulsion in an amount of at least 0.3 wt. % on total weight of the emulsion.
32. The process of any one of clauses 16 to 31, wherein the binding agent is present in the emulsion in an amount of at least 0.5 wt. % on total weight of the emulsion.
33. The process of any one of clauses 16 to 32, wherein the binding agent is methylcellulose or a combination of methylcellulose and at least one other hydrocolloid.
34. The process of any one of clauses 16 to 33, wherein the powdered vegetable fat is present in the emulsion in an amount of from 7.0 to 48.0 wt. %, on total weight of the emulsion.
35. The process of any one of clauses 16 to 34, wherein the powdered vegetable fat is present in the emulsion in an amount of from 10.0 to 45.0 wt. % on total weight of the emulsion.
36. The process of any one of clauses 16 to 35, wherein the powdered vegetable fat is present in the emulsion in an amount of from 12.5 to 42.0 wt. % on total weight of the emulsion.
37. The process of any one of clauses 16 to 36, wherein the liquid oil and the powdered vegetable fat are present in the emulsion in a combined amount of from 14.0 to 65.0 wt. % on total weight of the emulsion.
38. The process of any one of clauses 16 to 37, wherein the liquid oil and the powdered vegetable fat are present in the emulsion in a combined amount of from 20.0 to 60.0 wt. % on total weight of the emulsion.
39. The process of any one of clauses 16 to 38, wherein the liquid oil and the powdered vegetable fat are present in the emulsion in a combined amount of from 25.0 to 55.0 wt. % on total weight of the emulsion.
40. The process of any one of clauses 16 to 39, wherein the emulsion is comprising water in an amount of from 35.0 to 85.0 wt. %.
41. The process of any one of clauses 16 to 40, wherein the emulsion is comprising water in an amount of from 40.0 to 80.0 wt. %.
42. The process of any one of clauses 16 to 41, wherein the emulsion is comprising water in an amount of from 45.0 to 75.0 wt. %.
43. The process of any one of clauses 16 to 42, wherein the liquid oil and the powdered vegetable fat are present in the emulsion in a ratio liquid oil over powdered vegetable fat of from 0.3 to 3.0.
44. The process of any one of clauses 16 to 43, wherein the liquid oil and the powdered vegetable fat are present in the emulsion in a ratio liquid oil over powdered vegetable fat of from 0.5 to 2.0.
45. The process of any one of clauses 16 to 44, wherein the liquid oil and the powdered vegetable fat are present in the emulsion in a ratio liquid oil over powdered vegetable fat of from 0.7 to 1.3.
46. The process of any one of clauses 16 to 45, wherein the meat substitute product is a minced meat substitute product.
47. The process of any one of clauses 16 to 46, wherein the meat substitute product is a vegetarian protein product.
48. The process of any one of clauses 16 to 47, wherein the meat substitute product is uncooked.
49. The process of any one of clauses 16 to 48 wherein the process includes the preparation of the emulsion that is further mixed with hydrated texturized protein, and optionally other ingredients.
50. Use of an emulsion to improve the fat binding ability in the preparation of a meat substitute product, and the emulsion is comprising:
   a binding agent
   a liquid oil
   a powdered vegetable fat, and
   water,
wherein the powdered vegetable fat is a randomly interesterified fat having a fatty acid comprising saturated fatty acids with a carbon chain length of 12 to 22 (C12-C22), and having a ratio of saturated fatty acids with a carbon chain length of 12 and 14 (C12-C14) over saturated fatty acids with a carbon chain length of from 16 to 22 (C16-C22) of from 0.30 to 1.00.
51. Use of an emulsion to improve the fat binding ability in the preparation of a meat substitute product, and the emulsion is comprising:
   a binding agent
   a liquid oil
   a powdered vegetable fat, and
   water,
wherein the powdered vegetable fat is a randomly interesterified fat having a fatty acid comprising saturated fatty acids with a carbon chain length of 12 to 22 (C12-C22), and having a ratio of saturated fatty acids with a carbon chain length of 12 and 14 (C12-C14) over saturated fatty acids with a carbon chain length of from 16 to 22 (C16-C22) of from 0.40 to 1.00.
52. Use of an emulsion to improve the fat binding ability in the preparation of a meat substitute product, and the emulsion is comprising:
   a binding agent
   a liquid oil
   a powdered vegetable fat, and
   water,
wherein the powdered vegetable fat is a randomly interesterified fat having a fatty acid comprising saturated fatty acids with a carbon chain length of 12 to 22 (C12-C22), and having a ratio of saturated fatty acids with a carbon chain length of 12 and 14 (C12-C14) over saturated fatty acids with a carbon chain length of from 16 to 22 (C16-C22) of from 0.40 to 0.90.
53. Use of an emulsion to improve the fat binding ability in the preparation of a meat substitute product, and the emulsion is comprising:
   a binding agent
   a liquid oil
   a powdered vegetable fat, and
   water,
wherein the powdered vegetable fat is a randomly interesterified fat having a fatty acid comprising saturated fatty acids with a carbon chain length of 12 to 22 (C12-C22), and having a ratio of saturated fatty acids with a carbon chain length of 12 and 14 (C12-C14) over saturated fatty acids with a carbon chain length of from 16 to 22 (C16-C22) of from 0.50 to 0.8.
54. The use of any one of clauses 50 to 53 wherein the emulsion is present in an amount of from 20 to 50 wt. % on total weight of the meat substitute product.
55. The use of any one of clauses 50 to 54 wherein the emulsion is present in an amount of from 25 to 45 wt. % on total weight of the meat substitute product.
56. The use of any one of clauses 50 to 55 wherein the emulsion is present in an amount of from 30 to 40 wt. % on total weight of the meat substitute product.
57. The use of any one of clauses 50 to 56, wherein the randomly interesterified fat has a fatty acid moiety comprising a combined content of saturated fatty acids with a carbon chain length of 12 and 14 in range of from 16 to 40 wt. %, and a combined content of saturated fatty acids with a carbon chain length of from 16 to 22 in a range of from 40 to 65 wt. %, from 44 to 62 wt. %, or from 48 to 60 wt. % on total weight of the fatty acid moiety.
58. The use of any one of clauses 50 to 57, wherein the randomly interesterified fat has a fatty acid moiety comprising a combined content of saturated fatty acids with a carbon chain length of 12 and 14 in range of from 20 to 38 wt. %, and a combined content of saturated fatty acids with a carbon chain length of from 16 to 22 in a range of from 40 to 65 wt. %, from 44 to 62 wt. %, or from 48 to 60 wt. % on total weight of the fatty acid moiety.
59. The use of any one of clauses 50 to 58, wherein the randomly interesterified fat has a fatty acid moiety comprising a combined content of saturated fatty acids with a carbon chain length of 12 and 14 in range of from 25 to 35 wt. %, and a combined content of saturated fatty acids with a carbon chain length of from 16 to 22 in a range of from 40 to 65 wt. %, from 44 to 62 wt. %, or from 48 to 60 wt. % on total weight of the fatty acid moiety.
60. The use of any one of clauses 50 to 59, wherein the randomly interesterified fat has a fatty acid moiety comprising a combined content of saturated fatty acids with a carbon chain length of 12 and 14 in range of from 16 to 40 wt. %, and a combined content of saturated fatty acids with a carbon chain length of from 16 to 22 in a range of from 44 to 65 wt. %.
61. The use of any one of clauses 50 to 60, wherein the texturized protein ingredient is present in hydrated form in an amount of from 30 to 80 wt. % on total weight of the meat substitute product.
62. The use of any one of clauses 50 to 61, wherein the texturized protein ingredient is present in hydrated form in an amount of from 35 to 75 wt. % on total weight of the meat substitute product.
63. The use of any one of clauses 50 to 62, wherein the texturized protein ingredient is present in hydrated form in an amount of from 40 to 70 wt. % on total weight of the meat substitute product.
64. The use of any one of clauses 50 to 63, wherein the binding agent is present in the emulsion in an amount of at least 0.1 wt. % on total weight of the emulsion.
65. The use of any one of clauses 50 to 64, wherein the binding agent is present in the emulsion in an amount of at least 0.3 wt. % on total weight of the emulsion.
66. The use of any one of clauses 50 to 65, wherein the binding agent is present in the emulsion in an amount of at least 0.5 wt. % on total weight of the emulsion.
67. The use of any one of clauses 50 to 66, wherein the binding agent is methylcellulose or a combination of methylcellulose and at least one other hydrocolloid.
68. The use of any one of clauses 50 to 67, wherein the powdered vegetable fat is present in the emulsion in an amount of from 7.0 to 48.0 wt. %, on total weight of the emulsion.
69. The use of any one of clauses 50 to 68, wherein the powdered vegetable fat is present in the emulsion in an amount of from 10.0 to 45.0 wt. % on total weight of the emulsion.
70. The use of any one of clauses 50 to 69, wherein the powdered vegetable fat is present in the emulsion in an amount of from 12.5 to 42.0 wt. % on total weight of the emulsion.
71. The use of any one of clauses 50 to 70, wherein the liquid oil and the powdered vegetable fat are present in the emulsion in a combined amount of from 14.0 to 65.0 wt. % on total weight of the emulsion.
72. The use of any one of clauses 50 to 71, wherein the liquid oil and the powdered vegetable fat are present in the emulsion in a combined amount of from 20.0 to 60.0 wt. % on total weight of the emulsion.
73. The use of any one of clauses 50 to 72, wherein the liquid oil and the powdered vegetable fat are present in the emulsion in a combined amount of from 25.0 to 55.0 wt. % on total weight of the emulsion.
74. The use of any one of clauses 50 to 73, wherein the emulsion is comprising water in an amount of from 35.0 to 85.0 wt. %.
75. The use of any one of clauses 50 to 74, wherein the emulsion is comprising water in an amount of from 40.0 to 80.0 wt. %.
76. The use of any one of clauses 50 to 75, wherein the emulsion is comprising water in an amount of from 45.0 to 75.0 wt. %.
77. The use of any one of clauses 50 to 76, wherein the liquid oil and the powdered vegetable fat are present in the emulsion in a ratio liquid oil over powdered vegetable fat of from 0.3 to 3.0.
78. The use of any one of clauses 50 to 77, wherein the liquid oil and the powdered vegetable fat are present in the emulsion in a ratio liquid oil over powdered vegetable fat of from 0.5 to 2.0.
79. The use of any one of clauses 50 to 78, wherein the liquid oil and the powdered vegetable fat are present in the emulsion in a ratio liquid oil over powdered vegetable fat of from 0.7 to 1.3.
80. The use of any one of clauses 50 to 79, wherein the meat substitute product is a minced meat substitute product.
81. The use of any one of clauses 50 to 80, wherein the meat substitute product is a vegetarian protein product.
82. The use of any one of clauses 50 to 81, wherein the meat substitute product is uncooked.

### EXAMPLES

### 1. Recipe of the Meat Substitute Product

The recipes A to D of the meat substitute products are shown in table 1. The recipes of the emulsions A to D that were used in the recipe of the meat substitute products from table 1, are shown in table 2.

The composition of the vegetable fats A to D are shown in table 3. These vegetable fats were used in the emulsion (Table 2) in powdered form. The powders of fats A to D were obtained by spray-cooling the fats.

The vegetable fats A to D were also used in form of solid particles in the recipe of the meat substitute product (Table 1).

Randomly interesterified fats B to D were obtained by chemically interesterifying respectively fat blends B to D. The chemical interesterification is a process that is generally well known by the person skilled in the art. Composition of vegetable fat A (i.e. fat blend A) and fat blend B to D are shown in table 3.

TABLE 1
Recipes of the meat substitute products*

| | Recipe A | | | |
|---|---|---|---|---|
| | (comparative | | | |
| | example) | Recipe B | Recipe C | Recipe D |
| Emulsion | 37.5 wt. % | 37.5 wt. % | 37.5 wt. % | 37.5 wt. % |
| | Emulsion A | Emulsion B | Emulsion B | Emulsion B |
| Texturized pea | 33.9 wt. % | 33.9 wt. % | 33.9 wt. % | 33.9 wt. % |
| protein | | | | |
| (dehydrated)** | | | | |
| Water for | 18.0 wt. % | 18.0 wt. % | 18.0 wt. % | 18.0 wt. % |
| texturized | | | | |
| protein | | | | |
| hydration** | | | | |
| Pea protein | 4.0 wt. % | 4.0 wt. % | 4.0 wt. % | 4.0 wt. % |
| isolate | | | | |
| Carrageenan | 1.0 wt. % | 1.0 wt. % | 1.0 wt. % | 1.0 wt. % |
| Colors and | QS | QS | QS | QS |
| flavors | | | | |
| Salt | 1.0 wt. % | 1.0 wt. % | 1.0 wt. % | 1.0 wt. % |
| Solid fat | 4.0 wt. % | 4.0 wt. % | 4.0 wt. % | 4.0 wt. % |
| particles | Fat A | Fat B | Fat C | Fat D |

*Amount of ingredients expressed as wt. % on total weight of the meat substitute product
**The amount of hydrated texturized protein ingredient is the sum of the texturized protein ingredient in dehydrated from (here texturized pea protein) and the water for hydration of the texturized protein ingredient.

TABLE 2
Recipes of the emulsions***

| | Emulsion | Emulsion | Emulsion | Emulsion |
|---|---|---|---|---|
| | A | B | C | D |
| Methyl- | 2.6 wt. % | 2.6 wt. % | 2.6 wt. % | 2.6 wt. % |
| cellulose | | | | |
| Water | 76.0 wt. % | 76.0 wt. % | 76.0 wt. % | 76.0 wt. % |
| Rapeseed oil | 10.7 wt. % | 10.7 wt. % | 10.7 wt. % | 10.7 wt. % |
| Powdered | 10.7 wt. % | 10.7 wt. % | 10.7 wt. % | 10.7 wt. % |
| vegetable fat | Fat A | Fat B | Fat C | Fat D |

***Amount of ingredients expressed as wt. % on total weight of the emulsion

TABLE 3
Composition of the fats A to D, and fatty acid composition
and positional triglyceride composition of the fats

| | | | |
|---|---|---|---|
| Fat A | Fat B | Fat C | Fat D |

Composition of the fats

| | | | | |
|---|---|---|---|---|
| Palm stearin | 100 wt. % | | | |
| (IV34) | | | | |
| Palm | | | 50 wt. % | |
| superstearin | | | | |
| (IV14) | | | | |
| Fully | | 50 wt. % | | |
| hydrogenated | | | | |
| rapeseed oil | | | | |
| Cocoa butter | | | | 70 wt. % |
| Coconut oil | | 50 wt. % | 50 wt. % | 30 wt. % |

Fatty acid composition^{#}

| | | | | |
|---|---|---|---|---|
| C12 | 0.2 wt. % | 23.5 wt. % | 23.6 wt. % | 14.1 wt. % |
| C14 | 1.3 wt. % | 9.4 wt. % | 9.9 wt. % | 5.7 wt. % |
| X = C12 + C14 | 1.5 wt. % | 32.9 wt. % | 33.5 wt. % | 19.8 wt. % |
| C16 | 59.7 wt. % | 7.5 wt. % | 44.3 wt. % | 20.7 wt. % |
| C18 | 5.0 wt. % | 47.0 wt. % | 3.8 wt. % | 26.8 wt. % |
| C20 | 0.4 wt. % | 1.0 wt. % | 0.2 wt. % | 0.8 wt. % |
| C22 | 0.1 wt. % | 0.3 wt. % | 0 wt. % | 0.2 wt. % |
| Y = C16 + | 65.1 wt. % | 55.8 wt. % | 48.3 wt. % | 48.4 wt. % |
| C18 + C20 + | | | | |
| C22 | | | | |
| X/Y | 0.02 | 0.6 | 0.7 | 0.4 |

Positional triglyceride composition

| | | | |
|---|---|---|---|
| SUS/SSU | 0.5 | 0.5 | 0.5 |

^{#}Amount of each fatty acid expressed as wt. % on total weight of the fatty acid moiety of the fat.

### 2. Preparation of the Meat Substitute Product

### Step a) Preparation of the Emulsion

The emulsion was prepared in a Thermomix.

Vegetable fat A to D in powdered form and liquid oil were blended together according to the recipes of the emulsions A to D as described in table 2. Methylcellulose was added to the oil/fat blend and homogenized well by slowly mixing. Ice chilled water (at a temperature of less than 4° C.) is subsequently added while mixing at high speed. The emulsion was formed by mixing at high speed for 3 minutes. The emulsion was stored in the refrigerator (4° C.) until further use in step b).

### Step b) Preparation of a Meat Substitute Dough

Water for hydrating the texturized protein ingredient was added into a Stephan mixer according to the recipes A to D of meat substitute product as described in table 1. Colorants and flavours were dispersed into the water. The texturized pea protein ingredient in dry form was added to the water and left to hydrate for 15 minutes under vacuum while slowly mixing. The hydrated texturized pea protein was transferred to a Kenwood mixer where the remaining ingredients were added and mixed without applying vacuum. Pea protein isolate was added and mixed for 4 minutes at slow speed. Subsequently, carrageenan and salt were added and mixed for 4 minutes at slow speed. Afterwards, the emulsion A to D was added and mixed for 4 minutes at slow speed. Finally, particles of fat A to D were added and blend for 2 minutes at higher speed.

A meat substitute dough was obtained that was stored overnight at 4° C.

Step c) Shaping of the Meat Substitute Dough into a Form

The meat substitute dough was shaped into patties.

### 3. Evaluation of the Meat Substitute Product

### Evaluation of Meat Substitute Product Losses During Preparation

The percentage of meat substitute dough that was lost during shape forming into patties due to high stickiness to the equipment was measured for recipe A and B. Results are shown in table 4.

### Sensorial Evaluation

Frozen, patty-shaped meat substitute products were baked for 11 minutes at 180° C.

Following sensorial characteristics were evaluated for recipe A and B by a taste panel of 6 to 9 trained panelists:
Hardness: The force required to bite completely through the sample using the molars. Reference scores: 3=Vienna sausage/9=peanut
Juiciness: The amount of juice/moisture released from the sample, as perceived in the mouth. Reference scores: 2=carrot/8=cucumber
Graininess/Coarse mouthfeel: The amount of roughness felt with the tongue on the surface of the chewed mass. Reference scores: 5=biscuit/9=cereal bar
Oily mouthfeel: The amount of oily residue felt by the tongue when moved over the surfaces of the mouth. Reference scores: 6=fried chips

TABLE 4
Evaluation of the meat substitute products

| | Recipe A | |
|---|---|---|
| | (comparative | |
| | example) | Recipe B |
| Forming losses | 0.09% | 0.06% |

Sensorial evaluation

| | | |
|---|---|---|
| Hardness | 4.7 | 4.6 |
| Juiciness | 4.2 | 5.4 |
| Graininess/Coarse | 5.6 | 5.9 |
| mouthfeel | | |
| Oily mouthfeel | 8.0 | 8.7 |

A reduced loss of product during formation of patties was demonstrated for the meat substitute product according to recipe B. The meat substitute product according to recipe B also had an improved juiciness while maintaining firmness of bite, oily mouthfeel and graininess within the same range as the comparative example A.

1. A meat substitute product comprising a texturized protein ingredient and an emulsion that is comprising:
a binding agent
a liquid oil
a powdered vegetable fat, and
water,
wherein the powdered vegetable fat is a randomly interesterified fat having a fatty acid comprising saturated fatty acids with a carbon chain length of 12 to 22 (C12-C22), and having a ratio of saturated fatty acids with a carbon chain length of 12 and 14 (C12-C14) over saturated fatty acids with a carbon chain length of from 16 to 22 (C16-C22) of from 0.30 to 1.00, from 0.40 to 0.90, or from 0.50 to 0.8, and
wherein the emulsion is present in an amount of from 20 to 50 wt. %, from 25 to 45 wt. %, or from 30 to 40 wt. % on total weight of the meat substitute product.

2. The meat substitute product of claim 1 prepared by adding an emulsion to a texturized protein ingredient and the emulsion is comprising:
a binding agent
a liquid oil
a powdered vegetable fat, and
water,
wherein the powdered vegetable fat is a randomly interesterified fat having a fatty acid comprising saturated fatty acids with a carbon chain length of 12 to 22 (C12-C22), and having a ratio of saturated fatty acids with a carbon chain length of 12 and 14 (C12-C14) over saturated fatty acids with a carbon chain length of from 16 to 22 (C16-C22) of from 0.30 to 1.00, from 0.40 to 0.90, or from 0.50 to 0.8.

3. The meat substitute product according to claim 1, wherein the randomly interesterified fat has a fatty acid moiety comprising a combined content of saturated fatty acids with a carbon chain length of 12 and 14 in range of from 16 to 40 wt. %, from 20 to 38 wt. %, or from 25 to 35 wt. %, and a combined content of saturated fatty acids with a carbon chain length of from 16 to 22 in a range of from 40 to 65 wt. %, from 44 to 62 wt. %, or from 48 to 60 wt. % on total weight of the fatty acid moiety.

4. The meat substitute product according to claim 1, wherein the texturized protein ingredient is present in hydrated form in an amount of from 30 to 80 wt. % from 35 to 75 wt. %, or from 40 to 70 wt. % on total weight of the meat substitute product.

5. The meat substitute product according to claim 1, wherein the binding agent is present in the emulsion in an amount of at least 0.1 wt. %, at least 0.3 wt. %, or at least 0.5 wt. % on total weight of the emulsion.

6. The meat substitute product according to claim 1, wherein the binding agent is methylcellulose or a combination of methylcellulose and at least one other hydrocolloid.

7. The meat substitute product according to claim 1, wherein the powdered vegetable fat is present in the emulsion in an amount of from 7.0 to 48.0 wt. %, from 10.0 to 45.0 wt. %, from 12.5 to 42.0 wt. % on total weight of the emulsion.

8. The meat substitute product according to claim 1, wherein the liquid oil and the powdered vegetable fat are present in the emulsion in a combined amount of from 14.0 to 65.0 wt. %, from 20.0 to 60.0 wt. %, or from 25.0 to 55.0 wt. % on total weight of the emulsion.

9. The meat substitute product according to claim 1, wherein the emulsion is comprising water in an amount of from 35.0 to 85.0 wt. %, from 40.0 to 80.0 wt. %, or from 45.0 to 75.0 wt. %.

10. The meat substitute product according to claim 1, wherein the liquid oil and the powdered vegetable fat are present in the emulsion in a ratio liquid oil over powdered vegetable fat of from 0.3 to 3.0, from 0.5 to 2.0, from 0.7 to 1.3.

11. The meat substitute product according to claim 1, wherein the meat substitute product is a minced meat substitute product.

12. The meat substitute product according to claim 1, wherein the meat substitute product is uncooked.

13. A process for preparing a meat substitute product according to any one of the preceding claims and the process is comprising the steps of:
a) mixing hydrated texturized protein, with an emulsion, and optionally other ingredients, and obtaining a meat substitute dough, and
b) shaping of the meat substitute dough into a form,
wherein the emulsion is comprising:
a binding agent
a liquid oil
a powdered vegetable fat, and
water,
wherein the powdered vegetable fat is a randomly interesterified fat having a fatty acid comprising saturated fatty acids with a carbon chain length of 12 to 22 (C12-C22), and having a ratio of saturated fatty acids with a carbon chain length of 12 and 14 (C12-C14) over saturated fatty acids with a carbon chain length of from 16 to 22 (C16-C22) of from 0.30 to 1.00, from 0.40 to 0.90, or from 0.50 to 0.8.

14. The process according to claim 13 wherein the process includes the preparation of the emulsion that is further mixed with hydrated texturized protein, and optionally other ingredients.

15. Use of an emulsion to improve the fat binding ability in the preparation of a meat substitute product, and the emulsion is comprising:
a binding agent
a liquid oil
a powdered vegetable fat, and
water,
wherein the powdered vegetable fat is a randomly interesterified fat having a fatty acid comprising saturated fatty acids with a carbon chain length of 12 to 22 (C12-C22), and having a ratio of saturated fatty acids with a carbon chain length of 12 and 14 (C12-C14) over saturated fatty acids with a carbon chain length of from 16 to 22 (C16-C22) of from 0.30 to 1.00, from 0.40 to 0.90, or from 0.50 to 0.8.
